(19) United States
(12) Patent Application Publication
(10) Pub. No.: US 2018/0163891 A1
(43) Pub. Date: Jun. 14, 2018

(54) Fluid Pressure Bistable Valve

(71) Applicant: Novatek IP, LLC, Provo, UT (US)

(72) Inventors: D. Peter Johnson, Provo, UT (US); Scott Dahlgren, Alpine, UT (US)

(21) Appl. No.: 15/378,661

(22) Filed: Dec. 14, 2016

(51) Int. Cl. F16K 31/06

(52) U.S. Cl. CPC F16K 31/0693

(57) ABSTRACT

A valve may use fluid pressure to provide bistability to the valve by creating two regions that experience different pressures on one surface of the valve. The two regions may change in size relative to each other as the surface approaches another surface thus changing the combined pressures experienced by the regions. A velocity of fluid flow may increase as it passes one of the regions thus reducing pressure to that region. Additionally, an eddy current may form adjacent another one of the regions thus reducing pressure to that region. Consequently, the valve may be urged open when open and urged closed when closed.

### BACKGROUND

One common type of valve for handling fluids comprises a plug capable of obstructing a hole, known as a seat. Such plugs may be moved relative to the seat to permit or restrict fluid flowing therethrough. The valve may be considered bistable if the plug comprises two rest positions, one where the plug is generally seated on a seat (and obstructing a hole) and another where the plug is removed from the seat. In a bistable valve, if the plug is positioned midway between the rest positions it will tend to approach one rest position or the other and remain there until acted upon. In many situations, such bistable valves may require less power to operate as they maintain their current position until acted upon and may only require sufficient force to move the plug past a neutral position to actuate.

One example of a bistable valve is shown in U.S. Pat. No. 4,779,582 to Lequesne which describes a valve member latchable into open or closed positions by permanent magnetic poles against the force of compressed springs. A coil associated with each position, when activated with a current, cancels the magnetic field of the permanent magnetic pole holding the valve member and allows the compressed spring to move the member quickly through a central neutral position toward the other position, whereupon it is attracted by the other magnetic pole to compress the other spring and latch into the other position.

### BRIEF DESCRIPTION

A valve may use fluid pressure to provide bistability. This may be accomplished by forming a valve with a first surface positioned on a plug capable of engaging and disengaging with a second surface positioned on a seat as the plug translates relative to the seat. The first surface may comprise two regions, a leading region and a trailing region. The leading region and trailing region may be exposed to different fluid pressures, each comprising a force component situated parallel to the direction of translation of the plug. To create bistability, the leading pressure and trailing pressure may change based on how far the plug is from the seat. Specifically, when the first surface sits adjacent the second surface the leading pressure and trailing pressure may combine to draw the plug toward the seat. However, when the first surface sits remotely from the second surface the leading pressure and trailing pressure may combine to urge the plug away from the seat.

This may be accomplished in several ways. First, the surface areas of the leading region and the trailing region may change due to their unique geometries when the first surface is positioned adjacent the second surface. Second, a velocity of fluid flowing past the leading region may increase as the first surface approaches the second surface. Third, an eddy current in a fluid positioned adjacent the trailing region may get stronger as a first surface approaches a second surface.

### DRAWINGS

FIG. 1 is a longitude-sectional view of an embodiment of a bistable valve comprising a plug translatable relative to a seat by a solenoid.

FIGS. 2-1 and 2-2 are longitude-sectional views of an embodiment of a plug shown remote from a seat and seated on a seat, respectively.

FIGS. 3-1 and 3-2 are perspective views of embodiments of a plug and a seat, respectively.

FIGS. 4-1 and 4-2 are representations of embodiments of fluid flow and pressure within a bistable valve.

### DETAILED DESCRIPTION

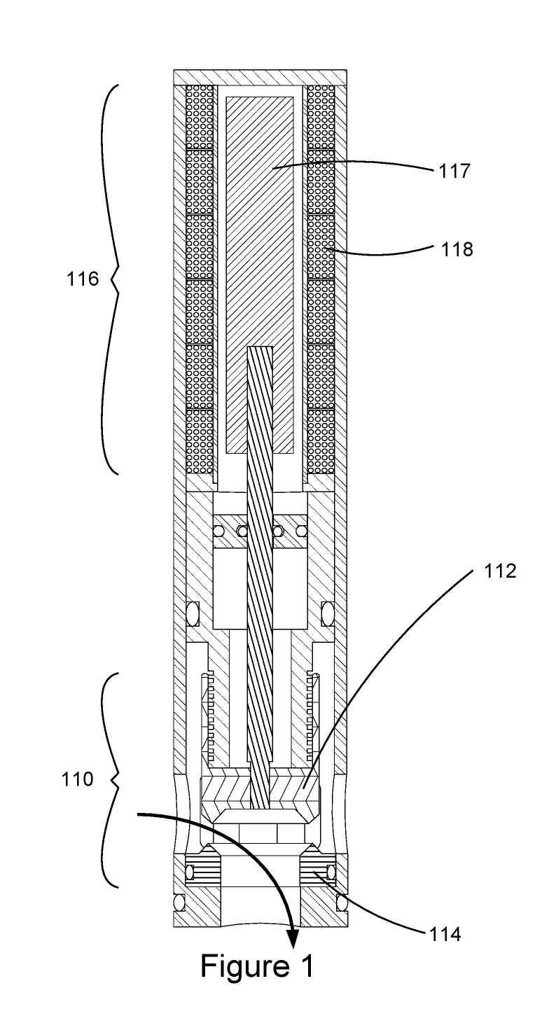

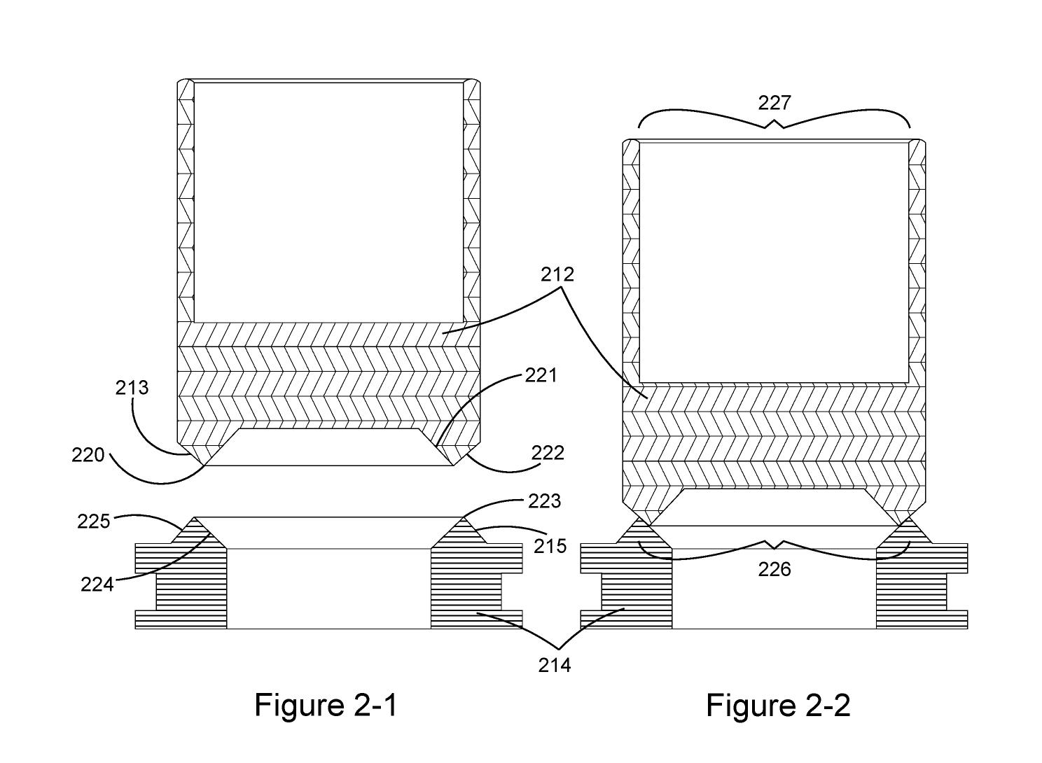

FIG. 1 shows an embodiment of a bistable valve 110 comprising a plug 112 positioned next to a seat 114. The plug 112 may be linearly translatable relative to the seat 114 by way of a solenoid actuator 116. The solenoid actuator 116 may comprise an armature 117, formed of ferrous material, attached to the plug 112 and surrounded by a solenoid coil 118 that may push or pull the armature 117 when electrically excited. While the embodiment shown in FIG. 1 comprises a linearly translatable plug, other embodiments may use other types of movements. FIGS. 2-1 and 2-2 show an embodiment of a plug 212 located in different positions relative to a seat 214. As seen in FIG. 2-1, a first surface 213, exposed on one end of the plug 212, may comprise an apex 220 extending therefrom toward the seat 214. The first surface 213 may comprise slopes 221, 222 adjacent the apex 220 on either side thereof. In the embodiment shown, the first surface 213 slopes away from the apex 220 at angles between 20 degrees and 50 degrees from a direction of translation of the first surface 213. Further, in various embodiments, the first surface 213 may slope away from the apex 220 at substantially equal angles on either side thereof.

Similarly, a second surface 215, exposed on one end of the seat 214, may comprise a protrusion 223 extending therefrom toward the plug 212. The second surface 215 may comprise slopes 224, 225 descending away from the protrusion 223 at angles of 20 degrees to 50 degrees on either side of the protrusion 223. In some embodiments these slopes 224, 225 are angled substantially equally.

As shown in FIG. 2-2, when the plug 212 is translated toward the seat 214, the first surface 213 may engage with the second surface 215 such that the protrusion 223 of the second surface 215 contacts the first surface 213. While contacting, the protrusion 223 may surround and overlap the apex 220 of the first surface 213. In order to statically balance the plug 212 when the plug 212 is exposed to fluid, a first area 226 bounded by the contact of the second surface 215 to the first surface 213 may be set equal to a second area 227 bounded by a seal of the plug 212 to an armature (not shown in FIG. 2-2). Such static balancing may reduce an amount of energy consumed by an actuator in moving the plug 112. However, in the embodiment shown, the second area 227 is 95 to 99 percent of the first area 226 such that the plug 112 experiences a slight force toward the seat 214 when surrounded by pressurized fluid. It is believed that as fluid pressures increase that this static balancing offset may become more pronounced.

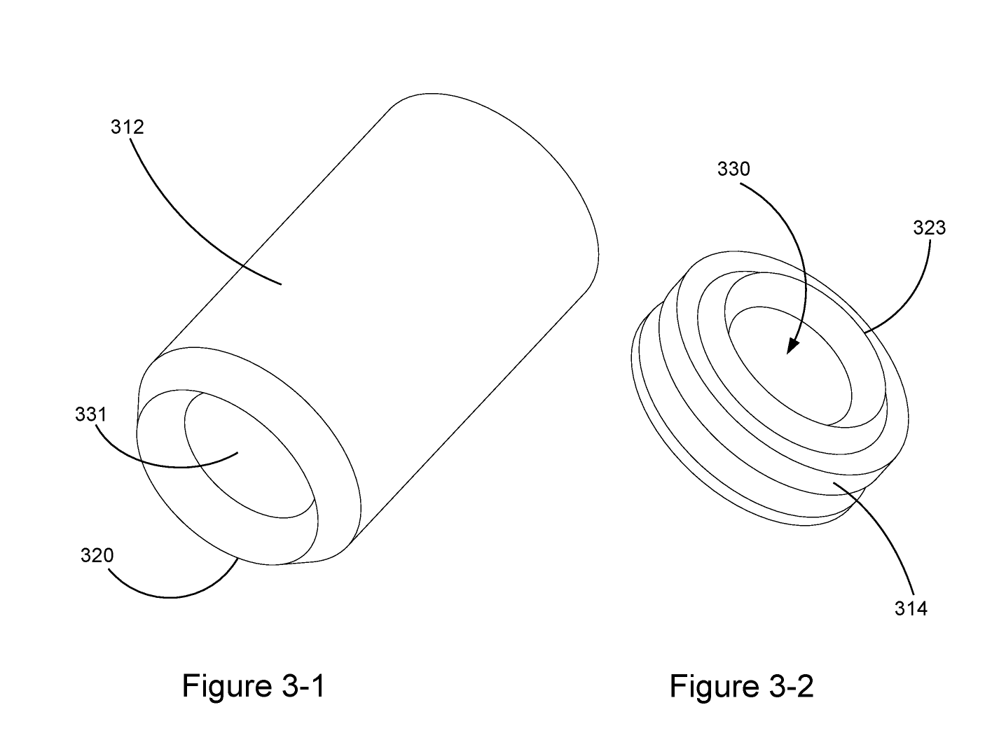

FIG. 3-1 shows an embodiment of a plug 312 and FIG. 3-2 shows an embodiment of a seat 314. Similar to embodiments discussed previously, the plug 312 may comprise an apex 320 forming a ring on the plug 312 and the seat 314 may comprise a protrusion 323 forming a ring on the seat 314. In operation, the plug 312 and seat 314 may be positioned such that the apex 320 ring and the protrusion 323 ring are coaxial. Additionally, while the protrusion 323 ring of the seat 314 surrounds a through hole 330 through which fluid may pass when the plug 312 is positioned remote from the seat 314, the apex 320 ring of the plug 312 may surround a concavity 330 formed in an end of the plug 312.

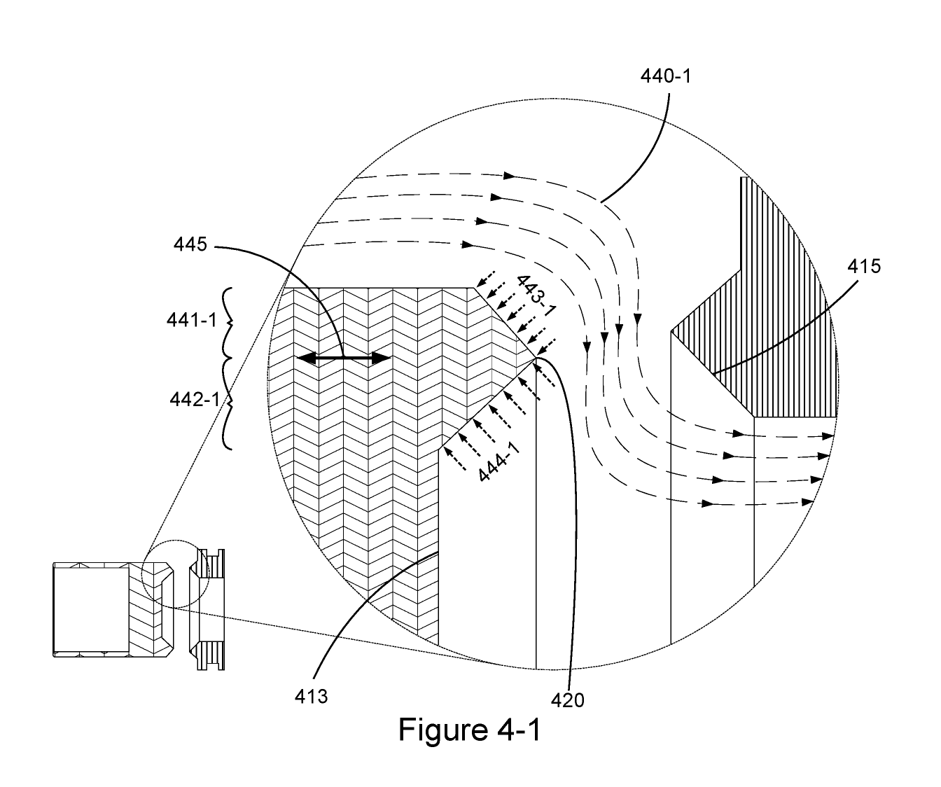

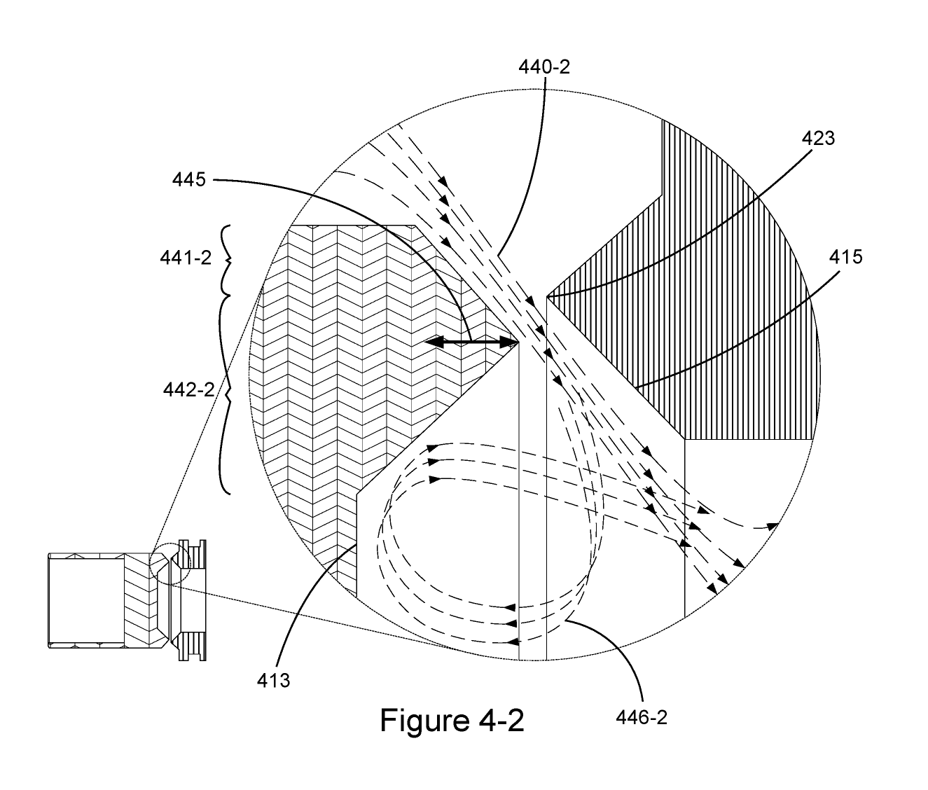

FIGS. 4-1 and 4-2 show embodiments of a fluid flow within a bistable valve. A first surface 413 of the bistable valve may comprise two regions, a leading region and a trailing region. This leading region and trailing region may change as the first surface 413 approaches a second surface 415. For example, in FIG. 4-1, a leading region 441-1 is disposed on one side of an apex 420 of the first surface 413 and a trailing region 442-1 is disposed on an opposite side of the apex 420. A fluid flow 440-1 may exert a leading pressure 443-1 on the leading region 441-1 while exerting a different trailing pressure 444-1 on the trailing region 442-1. Each of the leading pressure 443-1 and trailing pressure 444-1 may comprise force components positioned parallel to a direction of translation 445 of the first surface 413. A combination of the force components positioned parallel to the direction of translation 445 of the leading pressure 443-1 and trailing pressure 444-1 may urge the first surface 413 toward or away from the second surface 415.

When the first surface 413 is generally remote from the second surface 415, as shown in FIG. 4-1, a sum of the leading pressure 443-1 and the trailing pressure 444-1 may be positive thus urging the first surface 413 away from the second surface 415. However, when the first surface 413 moves closer to the second surface 415, as shown in FIG. 4-2, a new leading region 441-2 and new trailing region 442-2 may be formed on the first surface 413 on either side of a protrusion 423 of the second surface 415. This new leading region 441-2 and new trailing region 442-2 may experience new leading pressures and trailing pressures due to a variety of causes. For example, the new trailing region 442-2 may be larger in size relative to the new leading region 441-2 which may decrease the leading pressure when the first surface 413 is sitting adjacent the second surface 415 than when remote therefrom. A fluid flow 440-2 past the leading region 441-2 may increase in velocity due to a reduction in space leading to a decrease in leading pressure exerted upon the leading region 441-2. Additionally, an eddy current 446-2 may form adjacent the new trailing region 442-2 that may reduce a trailing pressure exerted upon the trailing region 442-2. This eddy current 446-2 may increase in strength as the first surface 413 approaches the second surface 415. Any or all of these causes may lead to a combination of the leading pressure and trailing pressure to be negative thus drawing the first surface 413 toward the second surface 415 when adjacent rather than urging them apart as happened when they were remotely located.

Whereas certain embodiments have been described in particular relation to the drawings attached hereto, it should be understood that other and further modifications apart from those shown or suggested herein, may be made within the scope and spirit of the present disclosure.

1. A bistable valve, comprising:
a first surface translatable relative to and capable of engaging and disengaging with a second surface;
the first surface comprising a leading region exposed to a leading pressure comprising a force component parallel to a direction of translation of the first surface; and
the first surface also comprising a trailing region exposed to trailing pressure also comprising a force component parallel to the direction of translation of the first surface; wherein
the leading pressure is different than the trailing pressure.

2. The bistable valve of claim 1, wherein the leading pressure and the trailing pressure are dependent on a distance between the first surface and the second surface.

3. The bistable valve of claim 1, further comprising an eddy current in a fluid positioned adjacent the trailing region.

4. The bistable valve of claim 3, wherein when the first surface is adjacent the second surface the eddy current is stronger than when the first surface is remote from the second surface.

5. The bistable valve of claim 1, wherein the first surface further comprises an apex extending therefrom in the direction of translation of the first surface.

6. The bistable valve of claim 5, wherein the first surface comprises angles of 20 degrees to 50 degrees from the direction of translation of the first surface on both sides of the apex.

7. The bistable valve of claim 6, wherein the first surface comprises substantially equal angles from the direction of translation of the first surface disposed on either side of the apex.

8. The bistable valve of claim 5, wherein when the first surface is remote from the second surface the leading region is disposed on one side of the apex and the trailing region is disposed on an opposite side of the apex.

9. The bistable valve of claim 1, wherein the second surface comprises a protrusion extending therefrom toward the first surface.

10. The bistable valve of claim 9, wherein when the first surface is engaged with the second surface, the protrusion of the second surface contacts the first surface.

11. The bistable valve of claim 10, further comprising a connection disposed opposite from the first surface on a mass, wherein an area of the connection is 95 to 99 percent of an area bounded by contact of the first surface and the second surface.

12. The bistable valve of claim 9, wherein when the first surface is adjacent the second surface the leading region is disposed on one side of the protrusion and the trailing region is disposed on an opposite side of the protrusion.

13. The bistable valve of claim 9, wherein the second surface comprises angles of 20 degrees to 50 degrees from a direction toward the first surface on both sides of the protrusion.

14. The bistable valve of claim 13, wherein the second surface comprises substantially equal angles from the direction toward the first surface disposed on either side of the protrusion.

15. The bistable valve of claim 1, wherein when the first surface is adjacent the second surface the leading pressure is less than when the first surface is remote from the second surface.

16. The bistable valve of claim 1, wherein when the first surface is adjacent the second surface a sum of the leading pressure and the trailing pressure is negative.

17. The bistable valve of claim 1, wherein the leading region comprises a ring that surrounds a concavity of the trailing region.

18. The bistable valve of claim 1, wherein both the first surface and second surface comprise coaxial rings.

19. The bistable valve of claim 18, wherein a protrusion extending from the second surface surrounds an apex of the first surface.

20. The bistable valve of claim 18, wherein a protrusion extending from the second surface overlaps an apex of the first surface in the direction of translation of the first surface.
